(19) United States
(12) Patent Application Publication
(10) Pub. No.: US 2010/0245870 A1
(43) Pub. Date: Sep. 30, 2010

(54) IMAGE PROCESSING APPARATUS, IMAGE FORMING APPARATUS, AND IMAGE PROCESSING METHOD

(76) Inventor: Tetsuya SHIBATA, Osaka (JP)

Correspondence Address: BIRCH STEWART KOLASCH & BIRCH, PO BOX 747, FALLS CHURCH, VA, 22040-0747, US

(21) Appl. No.: 12/731,804

(22) Filed: Mar. 25, 2010

(30) Foreign Application Priority Data
Mar. 27, 2009 (JP) 2009-080351

(51) Int. Cl. G06K 9/18; G06K 9/34; G06F 15/00

(52) U.S. Cl. 358/1.9; 382/182; 382/176

(57) ABSTRACT

An image processing apparatus includes: a recognition process section for performing, on the basis of image data of a document, a character recognition process of recognizing a character contained in the document; a chromatic text generation section for generating color text data (character image data) indicative of character images in which character images with different attributes are displayed with different colors; and an image composition section for generating composite image data by combining the image data of the document with the color text data so that each of the character images indicated by the color text data is partially superimposed on a corresponding image of a character in the document. The image processing apparatus causes a display device to display an image in accordance with the composite image data. This allows a user to easily check whether or not a result of the character recognition process is correct.

This Nonprovisional application claims priority under 35 U.S.C. §119(a) on Patent Application No. 2009-080351 filed in Japan on Mar. 27, 2009, the entire contents of which are hereby incorporated by reference.

### TECHNICAL FIELD

The present invention relates to an image processing apparatus, an image forming apparatus, and an image processing method each of which is for performing a character recognition process on image data.

### BACKGROUND ART

Conventionally, there has been a technique including the steps of: obtaining image data by reading information on a paper-medium document by use of a scanner; generating text data of characters in the image data by performing a character recognition process on the image data; and generating an image file in which the image data and the text data are correlated with each other.

For example, Patent Document 1 discloses a technique including the steps of: obtaining PDF image data by reading information on a paper medium by use of a scanner; generating text data by performing a character recognition process on the PDF image data; detecting a margin area of the PDF image data and a color of the margin area; and embedding, in the margin area of the PDF image data, the text data of a color that is the same as the color of the margin area. According to this technique, it is possible to embed the text data in the PDF image data without deteriorating an image quality, and perform a search process etc. by use of the text data embedded in the PDF image data. That is, because the text data of the same color as the color of the margin area is embedded in the margin area, the text data is not visible to a user. Accordingly, the image quality does not deteriorate. Further, based on the text data which is embedded in the margin area, information on a document can be extracted by performing, for example, a keyword search.

False recognition can be caused in the character recognition process. However, according to the technique of Patent Literature 1, a user cannot check a character recognition result. Therefore, the user cannot correct false recognition, if any.

On the other hand, Patent Literature 2 discloses a technique including the steps of: displaying image data read from a document as it is; performing a character recognition process on the image data; and displaying a dot pattern of a recognized character in such a manner that the dot pattern is superimposed on a character image of a corresponding character indicated by the image data so that the dot pattern may have a same size as the character image and have a color different from the character image.

### CITATION LIST

### Patent Literature 1

Japanese Patent Application Publication, Tokukai, No. 2004-280514 A (Publication Date: Oct. 7, 2004)

### Patent Literature 2

Japanese Patent Application Publication, Tokukaisho, No. 63-216187 A (Publication Date: Sep. 8, 1988)

### Patent Literature 3

Japanese Patent Application Publication, Tokukaihei, No. 7-192086 A (Publication Date: Jul. 28, 1995)

### Patent Literature 4

Japanese Patent Application Publication, Tokukai, No. 2002-232708 A (Publication Date: Aug. 16, 2002)

### SUMMARY OF INVENTION

According to the technique of Patent Literature 2, a character recognition result is displayed so as to completely cover an original character. This leads to a problem in that it is difficult to determine whether or not the character recognition result is correct. Particularly, in the case of a small character or a complex character, it is very difficult to determine whether or not the character recognition result is correct.

Another problem is that a user has a difficulty in distinguishing a recognized character from another one. This is because respective dot patterns of the recognized characters are displayed in a same color. In addition, in a case where a character whose character recognition result is discarded is deleted, it is necessary to individually extract the character to be deleted. This leads to further another problem in that an extra operation is required.

The present invention was made in view of the problems. An object of the present invention is to provide an image processing apparatus which allows a user to easily determine whether or not a character recognition result is correct, and easily edit the character recognition result.

In order to attain the object, an image processing apparatus of the present invention is an image processing apparatus for performing, on the basis of image data of a document, a character recognition process of recognizing a character contained in the document, the image processing apparatus including: a character image data generation section for generating character image data indicative of respective character images of characters recognized in the character recognition process; an image composition section for generating composite image data, the composite image data generated in such a manner that the image data of the document is combined with the character image data so that each of the character images indicated by the character image data is partially superimposed on a corresponding image of a character in the document; and a display control section for causing a display device to display an image in accordance with the composite image data, the character image data generation section determining a color of each of the character images in such a manner that character images with different attributes are displayed with different colors.

In order to attain the object, an image processing method of the present invention is an image processing method for performing, on the basis of image data of a document, a character recognition process of recognizing a character contained in the document, the image processing method including the steps of: (a) generating character image data indicative of respective character images of characters recognized in the character recognition process; (b) generating composite image data, the composite image data generated in such a manner that the image data of the document is combined with the character image data so that each of the character images indicated by the character image data is partially superimposed on a corresponding image of a character in the document; and (c) causing a display device to display an image in accordance with the composite image data, in the step of (a), a color of each of the character images being determined in such a manner that character images with different attributes are displayed with different colors.

According to the image processing apparatus and the image processing method, character image data is generated which indicates respective character images of characters recognized in the character recognition process; composite image data is generated by combining the image data of the document and the character image data so that each of the character images indicated by the character image data is partially superimposed on an image of a corresponding character in the document; and an image indicated by the composite image data is displayed by the display device. In addition, a color of each of the character images is determined in such a manner that character images with different attributes are displayed with different colors.

Accordingly, the character images indicated by the character image data and images of corresponding characters in the document are displayed so that each of the character images indicated by the character image data is partially superimposed on an image of a corresponding character in the document. This allows a user to compare more easily the characters in the document with the character recognition results. In addition, the character images based on the character recognition results are each displayed in a color which is changed according to a attribute of a character indicated by each of the character images. This allows a user to easily discriminate individual character recognition results. As a result, the user can easily determine whether or not the character recognition results are correct, and edit the character recognition results as needed. The attribute encompasses, e.g., a feature (e.g., fonts, character types (Chinese characters, hiraganas (Japanese cursive syllabary), katakanas (Square Japanese syllabary), alphanumeric characters, etc.), character size (point), etc.) of a character, a type of a region (e.g., text region and photograph region) in an image, and a page type (e.g., an odd page or an even page) in a document image.

### ADVANTAGEOUS EFFECTS OF INVENTION

As described above, an image processing apparatus of the present invention includes: a character image data generation section for generating character image data indicative of respective character images of characters recognized in the character recognition process; an image composition section for generating composite image data, the composite image data generated in such a manner that the image data of the document is combined with the character image data so that each of the character images indicated by the character image data is partially superimposed on a corresponding image of a character in the document; and a display control section for causing a display device to display an image in accordance with the composite image data, the character image data generation section determining a color of each of the character images in such a manner that character images with different attributes are displayed with different colors.

An image processing method of the present invention includes the steps of: (a) generating character image data indicative of respective character images of characters recognized in the character recognition process; (b) generating composite image data, the composite image data generated in such a manner that the image data of the document is combined with the character image data so that each of the character images indicated by the character image data is partially superimposed on a corresponding image of a character in the document; and (c) causing a display device to display an image in accordance with the composite image data, in the step of (a), a color of each of the character images being determined in such a manner that character images with different attributes are displayed with different colors.

Accordingly, the character images indicated by the character image data and images of corresponding characters in the document are displayed so that each of the character images indicated by the character image data is partially superimposed on an image of a corresponding character in the document. This allows a user to compare more easily the characters in the document with the character recognition results. In addition, the character images based on the character recognition results are each displayed in a color which is changed according to a attribute of a character indicated by each of the character images. This allows a user to easily discriminate individual character recognition results. As a result, the user can easily determine whether or not the character recognition results are correct, and edit the character recognition results as needed.

### BRIEF DESCRIPTION OF DRAWINGS

FIG. 1

FIG. 1 is a block diagram illustrating an arrangement of a character recognition section provided to an image processing apparatus of one embodiment of the present invention.

FIG. 2

FIG. 2 is a block diagram illustrating (i) a schematic arrangement of the image processing apparatus of the one embodiment of the present invention, and (ii) a data flow in an image forming mode.

FIG. 3

FIG. 3 is a block diagram illustrating a data flow of a case where character recognition results are displayed on the image processing apparatus illustrated in FIG. 2.

FIG. 4

FIG. 4 is a block diagram illustrating a data flow of a case where an image file is generated in which image data and the character recognition results are correlated with each other on the image processing apparatus illustrated in FIG. 2.

FIG. 5

FIG. 5 is a block diagram illustrating a schematic arrangement of a document detection section provided to the image processing apparatus illustrated in FIG. 2.

FIG. 6

FIG. 6 is an explanatory diagram illustrating one example of a relation between a reading area and a document position at the time of reading.

FIG. 7

FIG. 7 is a block diagram illustrating an arrangement of a modification of the image processing apparatus illustrated in FIG. 2.

FIG. 8

FIG. 8 is an explanatory diagram illustrating a layout analysis process which is performed by the document detection section illustrated in FIG. 5.

FIG. 9(a)

FIG. 9(a) is an explanatory diagram illustrating a method for setting a display method for displaying character recognition results.

FIG. 9(b)

FIG. 9(b) is an explanatory diagram illustrating a method for setting a display method for displaying character recognition results.

FIG. 9(c)

FIG. 9(c) is an explanatory diagram illustrating a method for setting a display method for displaying character recognition results.

FIG. 9(d)

FIG. 9(d) is an explanatory diagram illustrating a method for setting a display method for displaying character recognition results.

FIG. 10

FIG. 10 is an explanatory diagram illustrating one example of a display method for displaying character recognition results on the image processing apparatus illustrated in FIG. 2.

FIG. 11

FIG. 11 is an explanatory diagram illustrating one example of a display method for displaying character recognition results on the image processing apparatus illustrated in FIG. 2.

FIG. 12

FIG. 12 is an explanatory diagram illustrating one example of an editing method for editing character recognition results on the image processing apparatus illustrated in FIG. 2.

FIG. 13

FIG. 13 is an explanatory diagram illustrating one example of an editing method for editing character recognition results on the image processing apparatus illustrated in FIG. 2.

FIG. 14

FIG. 14 is an explanatory diagram illustrating one example of a method for placing a document to be read.

FIG. 15

FIG. 15 is an explanatory diagram illustrating one example of a method for setting a density level at which a document is read.

FIG. 16

FIG. 16 is a graph showing one example of a gamma curve which is used in a halftone correction process on the image processing apparatus illustrated in FIG. 2.

FIG. 17

FIG. 17 is an explanatory diagram illustrating an arrangement of an image file which is transmitted in an image transmission mode on the image processing apparatus illustrated in FIG. 2.

FIG. 18

FIG. 18 is a flowchart illustrating a processing flow of the image processing apparatus illustrated in FIG. 2.

FIG. 19

FIG. 19 is a block diagram illustrating a modification of the image processing apparatus illustrated in FIG. 2.

### DESCRIPTION OF EMBODIMENTS

The following describes one embodiment of the present invention. The present embodiment mainly deals with one example of application of the present invention to a digital color multifunction printer having functions such as a copier function, a printer function, a facsimile transmission function, and a Scan to E-mail function. However, the present invention is not applied only to the digital color multifunction printer but can be applied to any image processing apparatus which performs a character recognition process on image data.

(1) Overall Arrangement of Digital Color Multifunction Printer

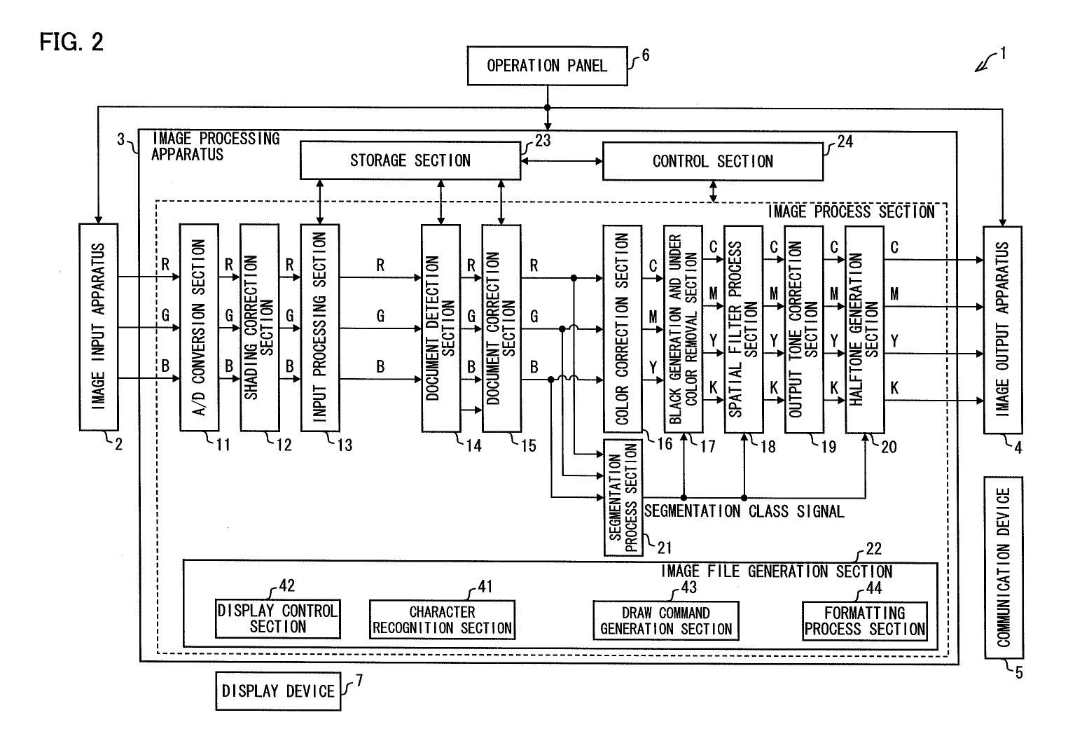

FIGS. 2 through 4 are block diagrams each schematically illustrating a digital color multifunction printer 1 of the present embodiment. The digital color multifunction printer 1 has (1) an image forming mode in which an image indicated by image data read by an image input apparatus 2 is formed on a recording material by an image output apparatus 4, and (2) an image transmission mode for transmitting, to an external device via a communication device 5, image data obtained by subjecting the image data read by the image input apparatus 2 to skew correction etc.

In the image transmission mode, a user can select whether to perform a character recognition process. In a case where the character recognition process is performed, the digital color multifunction printer 1 transmits, to the external device, an image file in which (i) the image data obtained by subjecting the image data read by the image input apparatus 2 to the skew correction etc. and (ii) text data obtained by subjecting the image data of (i) to the character recognition process are correlated with each other. In addition, in a case where the character recognition process is performed, a character recognition result is displayed before the image file containing the image data and the text data is generated. Therefore, a user can check and correct the displayed character recognition result.

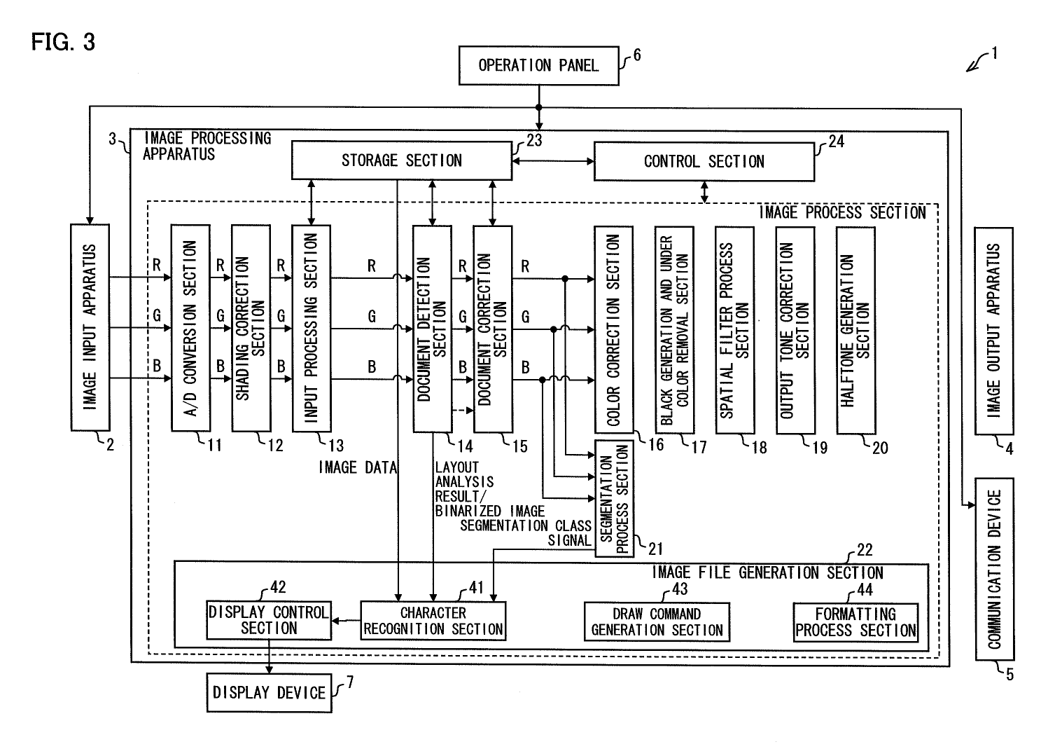

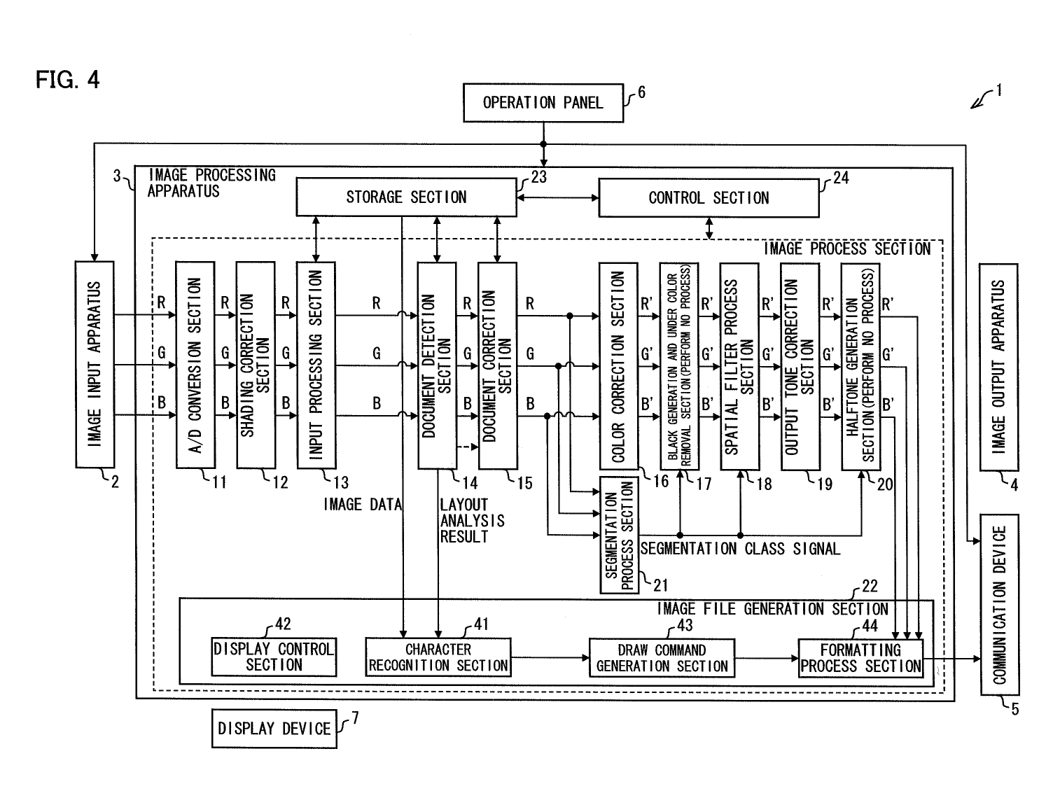

FIG. 2 shows a data flow in the image forming mode. FIG. 3 shows a data flow of a case where a character recognition result is displayed. FIG. 4 shows a data flow of a case where an image file in which image data and text data are correlated with each other is generated and transmitted to the external device.

As shown in FIGS. 2 through 4, the digital color multifunction printer 1 includes the image input apparatus 2, an image processing apparatus 3, the image output apparatus 4, the communication device 5, an operation panel 6, and a display device 7.

The image input apparatus 2 generates image data (image data of a document) by reading an image of a document. The image input apparatus 2 includes a scanner section (not illustrated) including a device, such as a CCD (Charge Coupled Device), for converting optical information into an electric signal. In the present embodiment, the image input apparatus 2 converts an optical image reflected from the document to an RGB (R: Red, G: Green, and B: Blue) analog signal, and outputs the RGB analog signal to the image processing apparatus 3. An arrangement of the image input apparatus 2 is not particularly limited. For example, the image input apparatus 2 can be an apparatus which reads a document placed on a scanner platen. Further, the image input apparatus 2 can be an apparatus which reads a document being fed by feed scanning means.

As shown in FIGS. 2 through 4, the image processing apparatus 3 includes an A/D (Analog/Digital) conversion section 11, a shading correction section 12, an input processing section 13, a document detection section 14, a document correction section 15, a color correction section 16, a black generation and under color removal section 17, a spatial filter process section 18, an output tone correction section 19, a halftone generation section 20, a segmentation process section 21, an image file generation section 22, a storage section 23, and a control section 24. The storage section 23 is storage means in which various data (e.g., image data) to be processed in the image processing apparatus 3 is stored. An arrangement of the storage section 23 is not particularly limited. For example, a hard disk can be used as the storage section 23. The control section 24 is control means for controlling operations of sections provided in the image processing apparatus 3. This control section 24 can be provided in a main control section (not illustrated) of the digital color multifunction printer 1. Alternatively, the control section 24 can be provided separately from the main control section and arranged to perform a process in cooperation with the main control section.

In the image forming mode, the image processing apparatus 3 outputs CMYK image data to the image output apparatus 4. This CMYK image data is obtained by performing various image processes on the image data inputted from the image input apparatus 2. In the image transmission mode, the image processing apparatus 3 performs various image processes on the image data inputted from the image input apparatus 2. In addition, the image processing apparatus 3 obtains text data by subjecting the image data to a character recognition process and generates an image file in which the image data and the text data are correlated with each other. Then, the image processing apparatus 3 outputs the image file to the communication device 5. Details of the image processing apparatus 3 are described later.

The image output apparatus 4 outputs, onto a recording material (e.g., paper), an image corresponding to the image data inputted from the image processing apparatus 3. An arrangement of the image output apparatus 4 is not particularly limited. For example, it is possible to adopt an electrophotographic image output apparatus or ink-jet image output apparatus, as the image output apparatus 4.

The communication device 5 is, for example, a modem or a network card. The communication device 5 performs data communication with other devices (e.g., a personal computer, a server, a display device, another digital multifunction printer, and a facsimile machine), connected with a network, via a network card, a LAN cable, or the like.

The operation panel 6 is made up of a setup button and a display section such as a liquid crystal display, and the like (not illustrated). The operation panel 6 transmits, to the main control section (not illustrated) of the digital color multifunction printer 1, information entered by a user via the setup button as well as displaying, on the display section, information in accordance with an instruction from the main control section. The user is allowed to input, from the control panel 6, various information such as a process mode for processing inputted image data, the number of sheets to be printed, a sheet size, a destination address etc.

The display device 7 displays an image obtained by combining an image indicated by image data read from a document by the image input apparatus 2 with a result of a character recognition process performed on the image data. The display device 7 can be with the same as the display section provided to the operation panel 6. The display device 7 can be a monitor of a personal computer or the like which is connected with the digital color multifunction printer 1 so that communication may be enabled therebetween. In this case, it can be arranged such that the display device 7 displays various kinds of setting windows (drivers) of the digital color multifunction printer 1 so that a user enters various instructions into the personal computer by use of instruction input devices provided to the computer system, such as a mouse and a keyboard. Some or all of the processes of the image processing apparatus 3 can be realized by a computer system such as a personal computer which is connected with the digital color multifunction printer 1 so that communication may be enabled therebetween.

The main control section is made of, for example, a CPU (Central Processing Unit) etc. By use of a program and various data which are stored in a ROM or the like (not illustrated), information entered from the operation panel 6, or the like, the main control section controls operations of respective sections of the digital color multifunction printer 1.

(2) Arrangement and Operation of Image Processing Apparatus 3

(2-1) Image Forming Mode

The following describes in more detail an arrangement of the image processing apparatus 3 and an operation of the image forming apparatus 3 in the image forming mode.

In the image forming mode, as shown in FIG. 2, the A/D conversion section 11 first converts the RGB analog signal inputted from the image input apparatus 2 into a digital signal and outputs the digital signal to the shading correction section 12.

The shading correction section 12 receives the digital RGB signal from the A/D conversion section 11 and subjects the digital RGB signal to a process of removing various distortions produced in an illumination system, an image-focusing system, and an image-sensing system of the image input apparatus 2. Then, the shading correction section 12 outputs the processed digital RGB signal to the input processing section 13.

The input processing section (input tone correction section) 13 adjusts a color balance of the RGB signal from which various distortions are removed in the shading correction section 12, and converts the RGB signal into a signal, such as a density signal, easy to handle for the image processing apparatus 3. The input processing section 13 also performs removal of background density and adjustment of image quality such as contrast. Further, the input processing section 13 stores, in the storage section 23, the image data processed as described above.

The document detection section 14 detects, from the image data subjected to the processes of the input processing section 13, a skew angle of a document image, a top-to-bottom direction, an image region which is a region where an image indicated by the image data is present, etc. Then, the document detection section 14 outputs the detection result to the document correction section 15. In addition, the document correction section 15 performs a skew correction process and a top-to-bottom direction correction process on the image data, on the basis of the detection result of the document detection section 14, and outputs the image data subjected to the processes to the color correction section 16 and the segmentation process section 21. It can be arranged such that: the document correction section 15 performs the skew correction process on the basis of the skew angle detection result of the document detection section 14; the document detection section 14 detects a top-to-bottom direction on the basis of the image data subjected to the skew correction process; and the document correction section 15 performs the top-to-bottom direction correction process on the basis of the top-to-bottom direction detection result of the document detection section 14. The document correction section 15 may perform the skew correction process and the top-to-bottom direction correction process on both binarized image data having a resolution reduced by the document detection section 14 and the document image data subjected to the processes of the input processing section 13.

The image data subjected to the skew correction process and the top-to-bottom direction correction process of the document correction section 15 can be treated as filing data. In such a case, the image data is stored in the storage section 23 after compressed into a JPEG code according to a JPEG compressing algorithm. In a case where a copy output operation and/or a print output operation directed to the image data is instructed, the JPEG code is taken out from the storage section 23 and transferred to an JPEG decoding section (not illustrated). Then, the JPEG code is subjected to a decoding process so as to be converted into RGB data. In a case where a transmission operation directed to the image data is instructed, the JPEG code is taken out from the storage section 23 and transmitted from the communication device 5 to an external device via a network or a communication line.

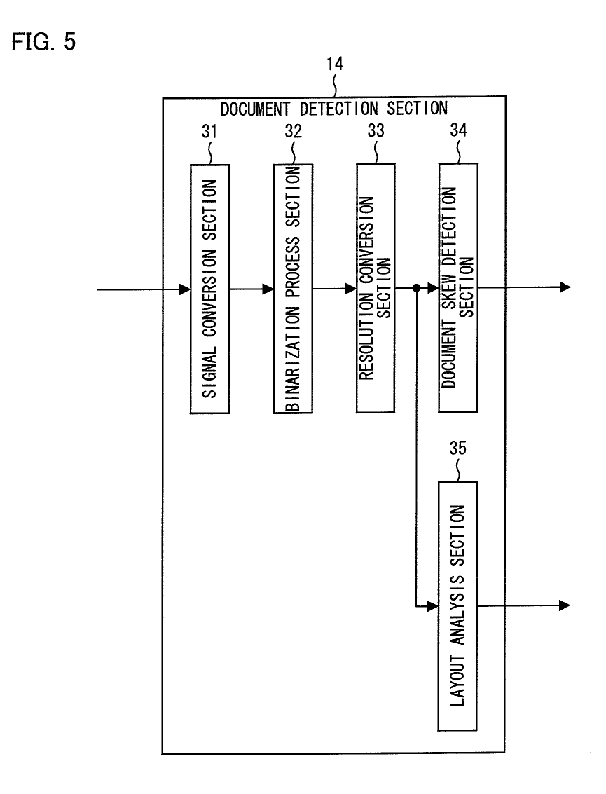

FIG. 5 is a block diagram schematically illustrating an arrangement of the document detection section 14. As shown in FIG. 5, the document detection section 14 includes a signal conversion section 31, a binarization process section 32, a resolution conversion section 33, a document skew detection section 34, and a layout analysis section 35.

In a case where the image data subjected to the processes of the input processing section 13 is color image data, the signal conversion section 31 converts the color image data into monochrome image data so as to convert the color image data into a brightness signal or a luminance signal.

For example, the signal conversion section 31 converts the RGB signal into a luminance signal Y by calculating Yi=0.30 Ri+0.59 Gi+0.11 Bi, where: Y is a luminance signal of each pixel; R, G, and B are respective color components of the RGB signal of each pixel; and a subscript i is a value (i is an integer equal to or greater than 1) given to each pixel.

Alternatively, the RGB signal may be converted into a CIE1976L*a*b* signal (CIE: Commission International de l'Eclairage, L*: Lightness; a* and b*: chromaticity). Alternatively, a G signal may be used.

The binarization process section 32 binarizes the monochrome image data by comparing the monochrome image data (luminance value (luminance signal) or brightness value (brightness signal)) with a predetermined threshold. For example, in a case where the monochrome image data is an 8-bit image data, the threshold is set to 128. Alternatively, an average value of densities (pixel values) in a block made up of a plurality of pixels (e.g., 5 pixels×5 pixels) can be set as the threshold.

The resolution conversion section 33 converts a resolution of the binarized image data to a low resolution. For example, image data read at 1200 dpi or 600 dpi is converted into image data of 300 dpi. A conversion method of the resolution is not particularly limited. It is possible to use, for example, a publicly-known method such as a nearest neighbor method, a bilinear interpolation method, and a bicubic interpolation method.

In the present embodiment, the resolution conversion section 33 generates image data by converting the resolution of the binary image data to a first resolution (300 dpi in the present embodiment), and generates another image data by converting the resolution of the binary image data to a second resolution (75 dpi in the present embodiment). Then, the resolution conversion section 33 outputs the image data of the first resolution to the document skew detection section 34, and outputs the image data of the second resolution to the layout analysis section 35. The layout analysis section 35 does not necessarily require high-resolution image data, provided that the layout analysis section 35 can schematically recognize a layout. Therefore, the layout analysis section 35 uses image data whose resolution is lower than image data used by the document skew detection section 34.

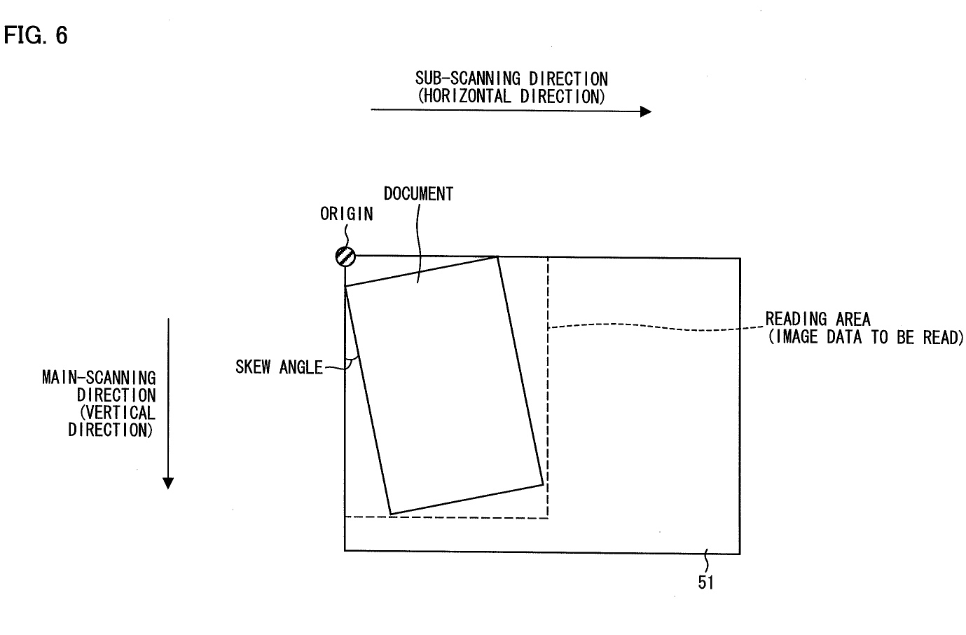

The document skew detection section 34 detects a skew angle of a document with respect to a reading range (regular document position) in image reading, based on the image data having the resolution reduced to the first resolution by the resolution conversion section 33, and outputs a result of the detection to the document correction section 15. That is, in a case where, as shown in FIG. 6, an angle of the document in image reading is skewed with respect to a reading range (regular document position) of the image input apparatus 2, the document skew detection section 34 detects the skew angle.

A method of detecting the skew angle is not particularly limited. It is possible to use various publicly-known methods. For example, a method described in Patent Literature 3 can be used. In this method, a plurality of boundary points between black pixels and white pixels (e.g., coordinates of black/white boundary points at an upper edge of each character) are extracted from the binarized image data, and coordinate data of a line formed by the boundary points is obtained. For a boundary between the black pixels and the white pixels, obtained are, e.g., coordinates of black/white boundary points at an upper edge of each character. Then, a regression line is obtained on the basis of the coordinate data of the line formed by the boundary points, and then, a regression coefficient b of the regression line is calculated according to the formula (1) below:

b=Sxy/Sx (1)

Sx is an error sum of squares of a variable x; Sy is an error sum of squares of a variable y; and Sxy is a sum of products each obtained by multiplying a residual of x by a residual of y. In other words, Sx, Sy and Sxy are represented by the following formulae (2) through (4):

$$\begin{matrix}Sx = {\sum }_{i = 1}^{n} {( {x}_{i} - x )}^{2} = {\sum }_{i = 1}^{n} {x}_{i}^{2} - {( {\sum }_{i = 1}^{n} {x}_{i} )}^{2} / n & ( 2 ) \\ Sy = {\sum }_{i = 1}^{n} {( {y}_{i} - y )}^{2} = {\sum }_{i = 1}^{n} {y}_{i}^{2} - {( {\sum }_{i = 1}^{n} {y}_{i} )}^{2} / n & ( 3 ) \\ Sxy = {\sum }_{i = 1}^{n} ( {x}_{i} - x ) ( {y}_{i} - y ) = {\sum }_{i = 1}^{n} {x}_{i} {y}_{i} - ( {\sum }_{i = 1}^{n} {x}_{i} ) ( {\sum }_{i = 1}^{n} {y}_{i} ) / n & ( 4 )\end{matrix}$$

Then, by using the regression coefficient b calculated as described above, a skew angle θ is calculated according to the following formula (5):

Tan θ=b (5)

In a case where a user selects the image transmission mode and chooses to perform the character recognition process, the layout analysis section 35 determines whether a direction of text contained in the image data is a vertical direction or a horizontal direction. The layout analysis section 35 does not operate in the image forming mode. Details of the layout analysis section 35 are described later.

The color correction section 16 converts the image data read out from the storage section 23 into a CMY (C: Cyan, M: Magenta, and Y: Yellow) signal which expresses complementary colors to the colors of the RGB signal. In addition, the color correction section 16 performs a process of improving color reproducibility.

The black generation and under color removal section 17 is for performing (i) black generation in which a black (K) signal is generated from the color-corrected three-color CMY signal, and (ii) subtracts the K signal from the original CMY signal so as to generate a new CMY signal. In this way, the three-color CMY signal is converted into four-color CMYK.

In accordance with the segmentation class signal, the spatial filter process section 18 performs a spatial filter process (edge enhancement process and/or smoothing process) by use of a digital filter, on image data of the CMYK signal inputted from the black generation and under color removal section 17, thereby correcting a spatial frequency characteristic of the image data. This makes it possible to reduce a blur or a granularity deterioration of an output image.

The output tone correction section 19 performs an output γ correction process on image data so that the image indicated by the image data may be outputted onto a recording material such as a sheet of paper, and outputs the image data subjected to the output γ correction process to the halftone generation section 20.

The halftone generation section 20 performs a tone reproduction process (halftone generation) in which an image is ultimately segmented into pixels so that respective tones of the pixels may be reproduced.

In accordance with the RGB signal, the segmentation process section 21 performs segmentation of each pixel of an inputted image into one of a black text region, a color text region, a halftone dot region, and a photograph region (continuous tone image region). According to a result of the segmentation, the segmentation process section 21 outputs a segmentation class signal indicative of a region to which a pixel belongs, to the black generation and under color removal section 17, the spatial filter process section 18, and the halftone generation section 20. In accordance with the inputted segmentation class signal, the black generation and under color removal section 17, the spatial filter process section 18, and the halftone generation section 20 each perform a process suitable for a corresponding region.

A method of the segmentation process is not particularly limited. For example, it is possible to employ a method disclosed in Patent Literature 4.

Calculated in the method are (i) a maximum density difference which is a difference between a minimum density and a maximum density of an n×m block (e.g., 15×15 pixels) containing a target pixel and (ii) a total density busyness which is a total of absolute values of density differences each found between adjacent pixels. Then, the maximum density difference is compared with a predetermined maximum density difference threshold, and the total density busyness is compared with a total density busyness threshold. On the basis of the comparison results, the target pixel is classified into a text edge region, a halftone dot region, or other regions (background region and photograph region).

Specifically, in general, a change in density is small in a density distribution of the background region. Accordingly, a maximum density difference and a total density busyness in the background region are very small. On the other hand, a density distribution of the photograph region (for example, a continuous tone image region such as a photograph is referred to as the photograph region) shows a gradual density change. Both a maximum density difference and a total density busyness are small but are somewhat greater than those of the background region. That is, in the background region and photograph region (i.e., in other regions), both a maximum density difference and a total density busyness take on small values.

In view of this, in a case where the maximum density difference is determined to be smaller than the maximum density difference threshold and the total density busyness is determined to be smaller than the total density busyness threshold, the target pixel is determined to reside in one of the other regions (i.e., in the background region or in the photograph region) region. Otherwise, the target pixel is determined to reside in the text edge region or the halftone dot region.

In a case where the target pixel is determined to reside in the text edge region or the halftone dot region, a calculated total density busyness is compared with a product of the maximum density difference and a character/halftone dot determination threshold so that the target pixel is classified into the text edge region or the halftone dot region.

Specifically, in a density distribution of the halftone dot region, the maximum density difference varies depending on types of halftone dots. However, the total density busyness accounts for a large proportion with respect to the maximum density difference because there are density changes as many as halftone dots. On the other hand, a density distribution of the text edge region shows a large maximum density difference. Accordingly, a total density busyness takes on a large value. However, the total density busyness is smaller than that of the halftone dot region since a density change is smaller than that of the halftone dot region.

In view of this, in a case where the total density busyness is greater than the product of the maximum density difference and the character/halftone dot determination threshold, the target pixel is determined to reside in the halftone dot region. In a case where the total density busyness is smaller than the product of the maximum density difference and the character/halftone dot determination threshold, the target pixel is determined to reside in the text edge region.

The image file generation section 22 includes a character recognition section 41, a display control section 42, a draw command generation section 43, and a formatting process section 44. In a case where the image transmission mode is selected, the image file generation section 22 performs the character recognition process as needed, and generates an image file to be transmitted to the external device. The image file generation section 22 does not operate in the image forming mode. Details of the image file generation section 22 are described later.

The image subjected to the aforementioned processes is temporarily stored in a memory (not illustrated), and then, read out from the memory at a predetermined timing so as to be inputted to the image output apparatus 4.

(2-2) Image Transmission Mode

The following describes in more detail an operation of the image processing apparatus 3 in the image transmission mode, with reference to FIGS. 3 and 4. Note that the respective processes performed by the A/D conversion section 11, the shading correction section 12, the input processing section 13, the document correction section 15, and the segmentation process section 21, and operations of the signal conversion section 31, the binarization process section 32, the resolution conversion section 33, and the document skew detection section 34, which are provided in the document detection section 14, are the same as those performed in the image forming mode.

In a case where the image transmission mode is selected in the present embodiment, a user can select whether to perform the character recognition process and whether to cause the display device 7 to display a character recognition results (i.e., whether to check and correct the character recognition results).

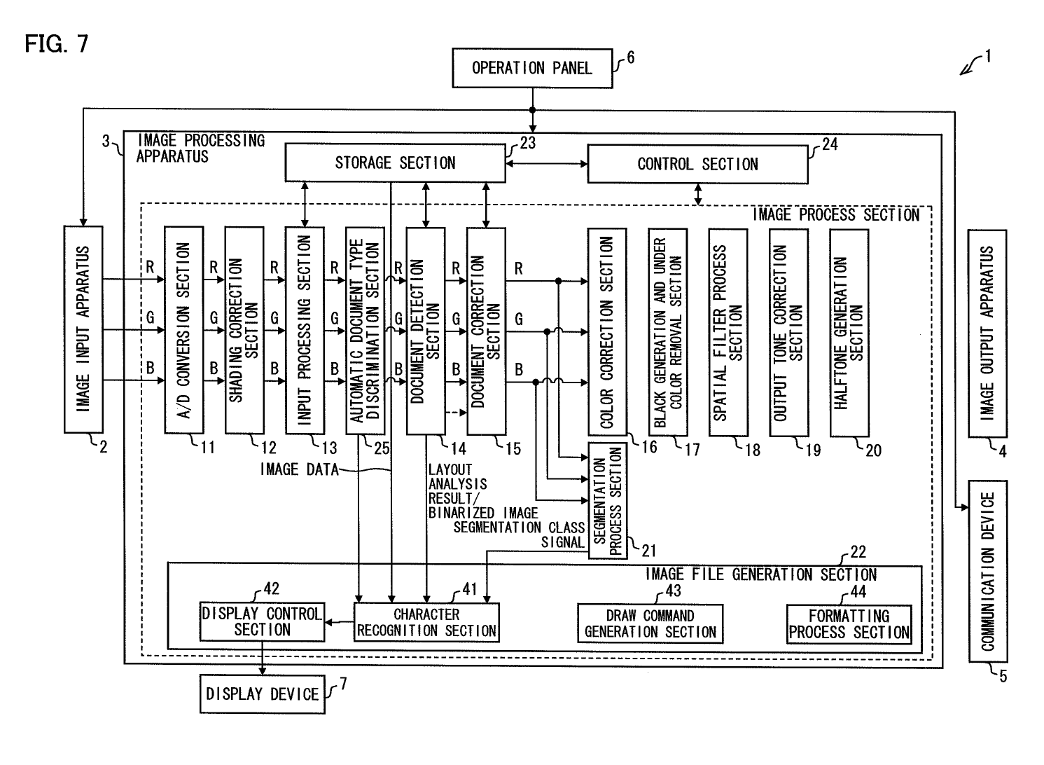

As shown in FIG. 7, the image processing apparatus 3 can be arranged such that an automatic document type discrimination section 25 for discriminating a type of a document on the basis of image data is provided upstream from the character recognition section 41, and a document type discrimination signal is supplied from the automatic document type discrimination section 25 to the character recognition section 41 so that the character recognition process may be performed in a case where the document type discrimination signal indicates that the document contains text (e.g., a text document, a text/printed-picture document, and a text/photograph document). A method for discrimination of a document type by the automatic document type discrimination section 25 is not particularly limited but can be any method, provided that at least a document containing text and a document containing no text can be discriminated from each other. It is possible to adopt various publicly-known methods as the method.

(2-2-1) Character Recognition Process

First, the character recognition process is described with reference to FIG. 3.

In a case where a user selects the image transmission mode and chooses to perform the character recognition process, the layout analysis section 35 determines whether a direction of text contained in image data is a vertical direction or a horizontal direction, and outputs the analysis result to the character recognition section 41 provided in the image file generation section 22.

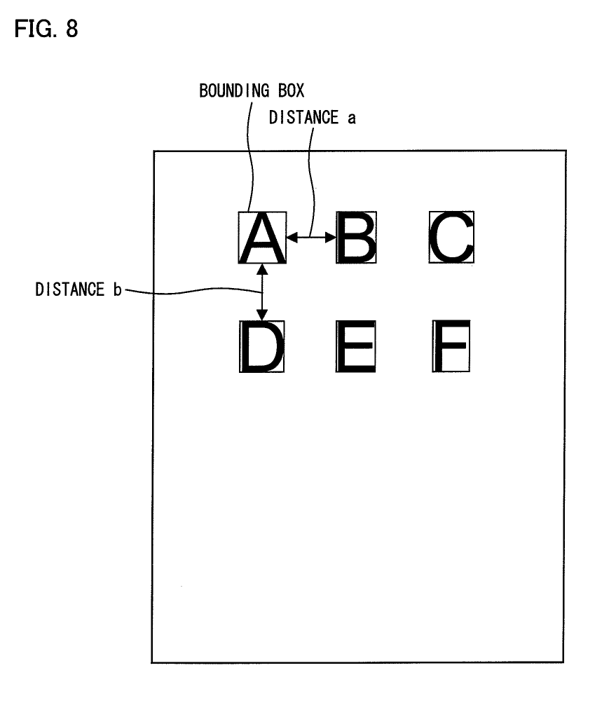

As shown in FIG. 8, specifically, the layout analysis section 35 extracts characters contained in that image data inputted from the resolution conversion section 33 which has the second resolution, and finds respective bounding boxes of the characters so as to calculate a distance between adjacent bounding boxes. On the basis of the distance, the layout analysis section 35 determines whether a direction of the text of the image data is the vertical direction or the horizontal direction. Further, the layout analysis section 35 outputs a signal indicative a result of the determination to the character recognition section 41 provided in the image file generation section 22.

Specifically, the layout analysis section 35 determines, for each pixel in the image data, whether or not each pixel included in the first line extending in a sub-scanning direction is a black pixel, and assigns a predetermined label to a pixel determined to be a black pixel.

Then, regarding a second line adjacent in a main-scanning direction to the first line to which labeling has been carried out, the layout analysis section 35 determines, for each pixel in the second line, whether each pixel in the second line is a black pixel or not. Then, the layout analysis section 35 assigns, to each pixel determined to be a black pixel in the second line, a label different from the label used in the first line for which labeling has been completed. Then, for each pixel determined to be a black pixel in the second line, it is determined whether an adjacent pixel that is in the first line for which labeling has been completed and that is adjacent to the pixel determined to be a black pixel in the second line is a black pixel or not. If the adjacent pixel in the first line is determined to be a black pixel, the layout analysis section 35 determines that black pixels are continuous, and changes the label of the pixel in the second line to the label (the label that is the same as the label for the first line one line above the second line) of the adjacent pixel that is adjacent to the pixel in the second line and that is in the first line for which labeling has been completed.

Then, the process above is repeated for each line aligned in the main-scanning direction. Then, the layout analysis section 35 extracts pixels to which the same label is assigned, thereby extracting each character.

Then, a bounding box of the each character extracted is extracted on the basis of: a top pixel position, a bottom pixel position, a leftmost pixel position, and a rightmost pixel position. Coordinates of each bounding box of the each character are calculated, for example, on the assumption that a top-leftmost position of the image data is an origin.

The layout analysis section 35 can be arranged to perform a layout recognition process for each region in the document. For example, the layout analysis section 35 can be arranged to individually extract regions each made up of characters whose bounding boxes are spaced at substantially equal distances, and to determine, for each of the extracted regions, whether the text is in vertical writing or horizontal writing.

The character recognition section 41 reads out, from the storage section 23, that binarized image data of the second resolution which has been subjected to the skew correction process and the top-to-bottom direction correction process of the document correction section 15, and performs the character recognition process on the binarized image data. In the case of image data which does not require the skew correction process and the top-to-bottom direction correction process, the character recognition section 41 may read out the binarized image data which has been outputted from the document detection section 14 and stored in the storage section 23, and perform the character recognition process on the binarized image data.

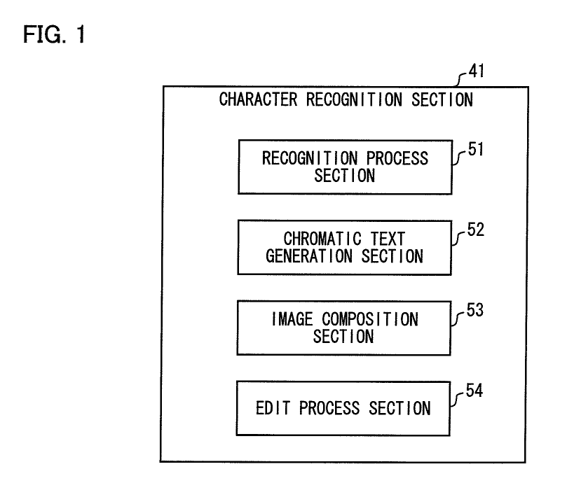

FIG. 1 is a block diagram illustrating an arrangement of the character recognition section 41. As illustrated in FIG. 1, the character recognition section 41 includes a recognition process section 51, a chromatic text generation section (character image data generation section) 52, an image composition section 53, and an edit process section 54.

The recognition process section 51 (i) extracts features of image data of the binarized image (luminance signal) having the resolution reduced to the second resolution by the document detection section 14, (ii) performs the character recognition process by comparing a result of the extraction with features of characters contained in dictionary data, (iii) finds a character code corresponding to a character having similar features, (iv) and stores the character code in a memory (not illustrated).

The chromatic text generation section 52 generates color text data (character image data) indicative of chromatic character images which respectively correspond to the character codes recognized by the recognition process section 51. A color of the color text can be set to a default color. Alternatively, the color of the color text can be selected by a user via the operation panel 6 or the like. For example, it can be arranged such that the user selects the color of the color text in a case where the user selects, via the operation panel 6, a mode in which the character recognition results are displayed. As for the selection of whether to display the character recognition results, it can be arranged such that the selection is not made at completion of the character recognition process but can be made by a user when the user selects the image transmission mode.

In the present embodiment, the chromatic text generation section 52 generates the chromatic character image data. Although the present embodiment is not limited to this, it is preferable to change respective colors of character images of the character recognition results differently from colors of corresponding character images in the document.

The present embodiment is arranged to change respective colors of the character images corresponding to the character recognition results according to attributes of corresponding characters in the document image. Examples of the attributes encompass a feature (e.g., fonts, character types (Chinese characters, hiraganas, katakanas, alphanumeric characters, etc.), character size (point), etc.) of a character, a type of a region (e.g., text region and photograph region) in an image, and a page type (e.g., an odd page or an even page) in a document image.

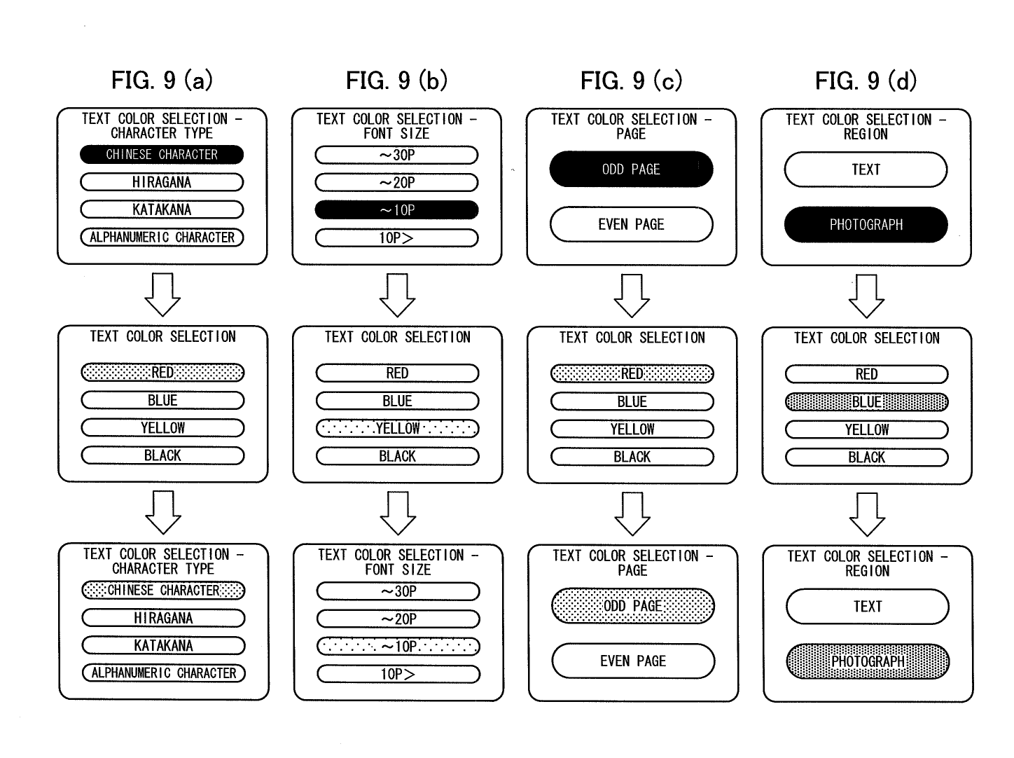

Display colors which respectively correspond to the attributes may be set as default colors. Alternatively, as shown in FIG. 9(a) through FIG. 9(d), the display colors may be freely set by the user. For example, in the case of FIG. 9(a), a screen image for prompting a user to enter his selection of a character type is displayed first. Upon selection of the character type, a screen image for prompting the user to input his selection of a color corresponding to the character type. Upon selection of the color, a display color of an image (button) corresponding to the character type is changed to the selected color. Colors which respectively correspond to the character types are set by repeating the process. As shown in FIG. 9(b) through FIG. 9(d), display colors for other attributes such as a character size, a page type, and a region type are also set by substantially the same method as the character types.

A font of character images of the character recognition results is not particularly limited. For example, the font can be one which is the same as or similar to a font of corresponding characters in a document image. Alternatively, the font can be freely set by a user. Also, a display size of character images of character recognition results is not particularly limited. For example, the display size can be substantially the same size as a size of corresponding characters in a document image, or can be smaller. The display size can be freely set by a user.

The image composition section 53 generates composite image data by combining image data read out from the storage section 23 with the color text data generated by the chromatic text generation section 52, and outputs the composite image data to the display control section 42. Specifically, the image composition section 53 superimposes the color text data on the document image data so that the character images indicated by the color text data may be displayed in the vicinity of corresponding images of characters in the document.

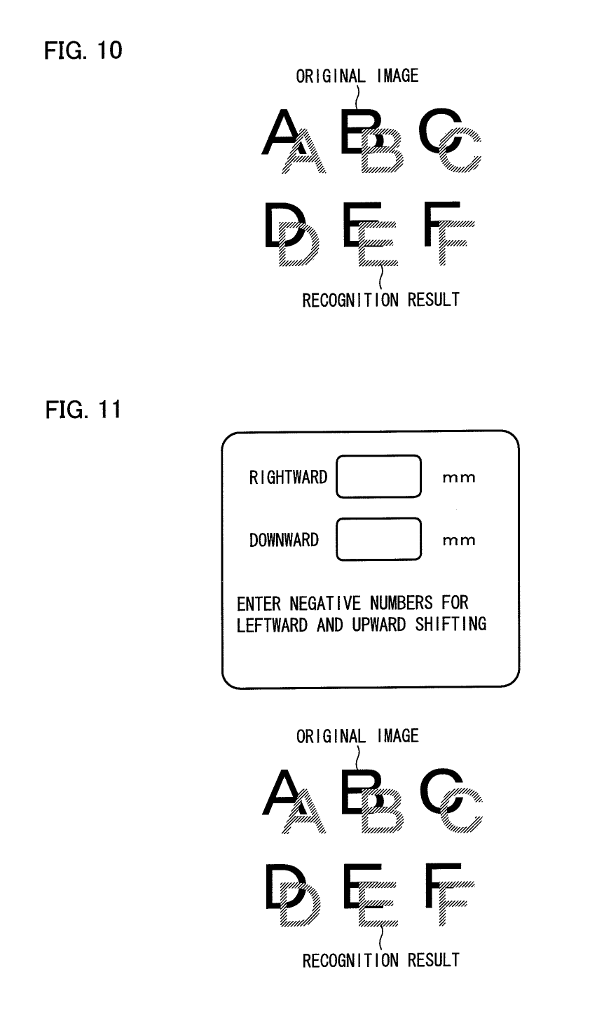

For example, as shown in FIG. 10, a position of each character image corresponding to the character recognition results is (i) shifted in a main-scanning direction, from a position of a corresponding character in the original document image, by approximately ½ of a width, along the main-scanning direction, of the corresponding character, and (ii) shifted in a sub-scanning direction by approximately ½ of a width, along the sub-scanning direction, of the corresponding character. Alternatively, the position of the character image can be shifted only in the main-scanning direction or only in the sub-scanning direction. A distance of the shift is not limited to approximately ½ of a width of a character. For example, the distance can be a distance corresponding to a predetermined number of pixels, or can be a predetermined distance.

It can be arranged such that a screen image for prompting a user to enter a shift amount of a character image corresponding to a character recognition result is displayed on the display section of the display device 7 or on the display section of the operation panel 6, and, in accordance with a user's response to the screen image, the amount is set. For example, the display control section 42 (mentioned later) causes a screen image in which the character recognition results are superimposed on the document image to display a message prompting a user to enter whether to change display positions of the character recognition results. In a case where the user chooses to change the display positions, boxes are displayed in which shift amounts (e.g., a length (unit: mm)) are entered by which the character recognition results are shifted in upward or downward, and leftward or rightward directions. In the example illustrated in FIG. 11, with reference to displayed positions, the user enters positive numbers in the boxes in the case of shifting in the rightward and downward directions. In the case of shifting in the leftward and upward directions, the user enters negative numbers in the boxes. It can be arranged such that a message explaining this is displayed in the vicinity of the boxes in which the shift amounts are entered, and the user enters desired numbers from the operation panel or the like.

The display control section 42 causes the display device 7 to display an image in accordance with composite image data generated by the image composition section 53. It can be arranged such that the image composition section 53 temporarily stores the composite image data in a memory (not illustrated) and the display control section 42 reads out the composite image data as needed so as to cause the display device 7 to display the composite image data.

In order that the whole document image may be displayed on the display screen of the display device 7, the display control section 42 may carry out processes such as thinning pixels out in accordance with a size, resolution, etc. of the display screen. A method for thinning pixels out is not particularly limited. For example, it is possible to adopt the following methods: (1) a nearest neighbor method (a method in which a value of an existing pixel nearest to a pixel to be interpolated or a value of an existing pixel having a predetermined positional relation with the pixel to be interpolated is employed as a value of the pixel to be interpolated), (2) a bilinear method (a method in which an average of values of four existing pixels surrounding a pixel to be interpolated is found in such a manner that the values are weighted in proportion to respective distances from the pixel to be interpolated, and the average is employed as a value of the pixel to be interpolated), and (3) a bicubic method (a method in which interpolation calculation is performed by using values of 16 pixels which values are made up of values of four pixels surrounding an interpolating pixel and values of 12 pixels surrounding the four pixels).

The display control section 42 can be arranged to perform, in accordance with characteristics etc. of the display device 7, a γ correction process on the composite image data generated by the image composition section 53, so as to cause the display device 7 to display the composite image data.

In a case where a plurality of candidate character recognition results are extracted for one character, the chromatic text generation section 52 may generate color text of characters which respectively correspond to the plurality of candidate character recognition results so that the characters are displayed in respective different colors and in respective different display positions. When the display device 7 displays the composite image generated by the image composition section 53, the display control section 42 may cause the display device 7 to display button images (e.g., images indicating a candidate 1 and a candidate 2) for selecting any one of a plurality of candidates, so that a user may select any one of the plurality of candidates. In this case, the candidate character recognition results can be displayed in such a manner that edges of the buttons are represented by color bold lines and/or entire surfaces of the buttons are displayed in color(s).

The edit process section 54 corrects those character recognition results which are obtained by the recognition process section 51 and then stored in the memory, in accordance with a user's edit instruction (instruction to delete or correct the character recognition results, or select a correct one from a plurality of candidate character recognition results) which is entered from the operation panel 6 in response to the character recognition results. On the basis of an image displayed on the display device 7 in accordance with the composite image data, a user determines (i) whether to edit the character recognition results and (ii) how the character recognition results should be edited. Then, the user enters a correction instruction from the operation panel 6, or a mouse, a keyboard, or the like. The display section provided to the display device 7 or to the operation panel 6 can be a touch panel so that a user may enter the correction instruction via the touch panel.

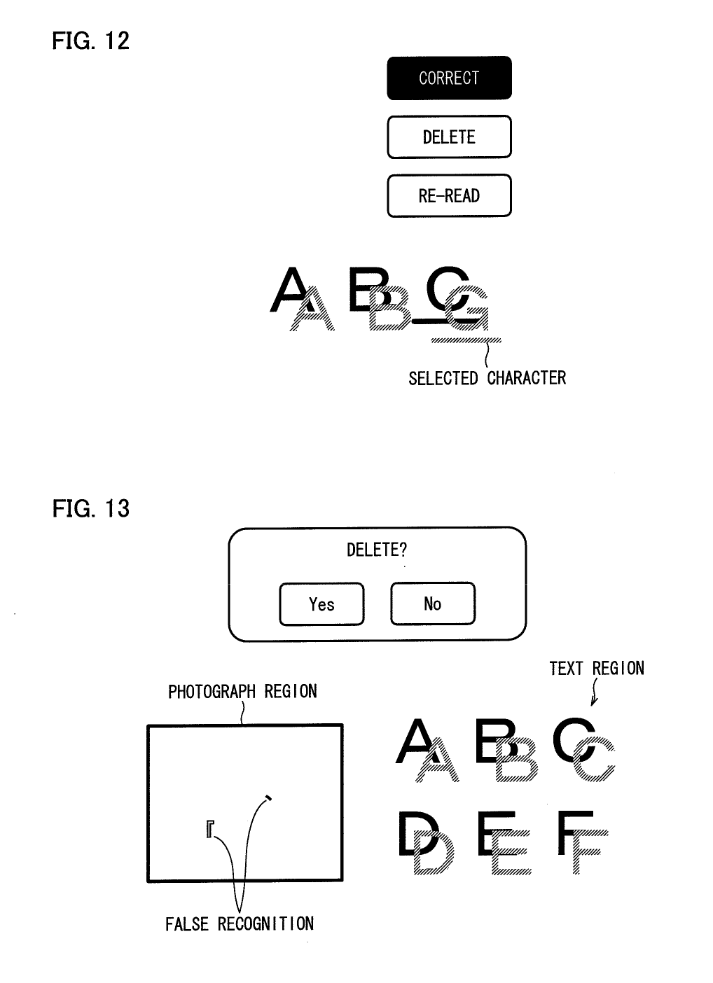

For example, as shown in FIG. 12, the display control section 42 causes the display device 7 to display buttons indicating: “Correct,” “Delete,” and “Re-read.” If a user needs to edit character recognition results, the user selects any one of the buttons via the operation panel 6 or the like.

For example, in the example illustrated in FIG. 12, a character which should be recognized as “C” is wrongly recognized as “G.” In this case, a user selects the “Correct” button via the operation panel or the like, then selects a character to be corrected (i.e., “G” in the example shown in FIG. 12), and then, enters a correct character (i.e., “C” in the example shown in FIG. 12).

If the user selects “Delete” in the screen image shown in FIG. 12, the display control section 42 causes the display device 7 to display a screen image for prompting the user to select a deletion method. Possible deletion methods are, for example, (1) to specify a character to be deleted, (2) to specify an attribute of a character to be deleted (or specify a color corresponding to the attribute of the character to be deleted), and (3) to specify a range to be deleted.

For example, assume the following: The method of (2) is selected as the deletion method; character recognition results are displayed in two different colors between a text region and a photograph region; and there is no need to perform character recognition process on the photograph region. In this case, by specifying (selecting) a color of the photograph region, a user can delete, at a time, the character recognition results in the photograph region. Further, assume that the text region and the photograph region are displayed so as to be distinguished from each other (e.g., a rectangle indicating an outer edge of the photograph region is displayed as shown in FIG. 13). In this case, by selecting a range corresponding to the photograph region (e.g., if the photograph region is a rectangle, four corner points of the rectangle are selected), a user can delete, at a time, the character recognition results in the photograph region. As shown in FIG. 13, the display control section 42 may display the message “Delete?” and buttons indicating “Yes” and “No,” and perform deletion if “Yes” is selected. Further, the character recognition section 41 may be configured in advance so as to generate, in accordance with the segmentation class signal inputted from the segmentation process section 21, a text map indicating the text region, so as to perform the character recognition process only on the text region. In the present embodiment, the character recognition process is performed on binarized image data. Therefore, even in the photograph area, false recognition can be caused in a case where the binarized data is similar to text (an alphabet, a parenthesis, a period, etc.).

It may be arranged such that the method of (2) is selectable only in a case where display colors are set according to the attributes of characters. In a case where the display colors are not set according to the attributes of the characters, a button or the like for selecting the method of (2) may, for example, be grayed out so that a user cannot select the method.

In a case where corrections are necessary in many places, a user can perform re-reading of a document in such a manner that the user selects the “Re-read” button in the screen image shown in FIG. 12, and then, for example, changes a read condition.

The read condition to be changed encompasses, for example, (1) an orientation of a document, (2) a resolution, (3) a density, (4) a background removal level, or a combination of at least two of the read conditions.

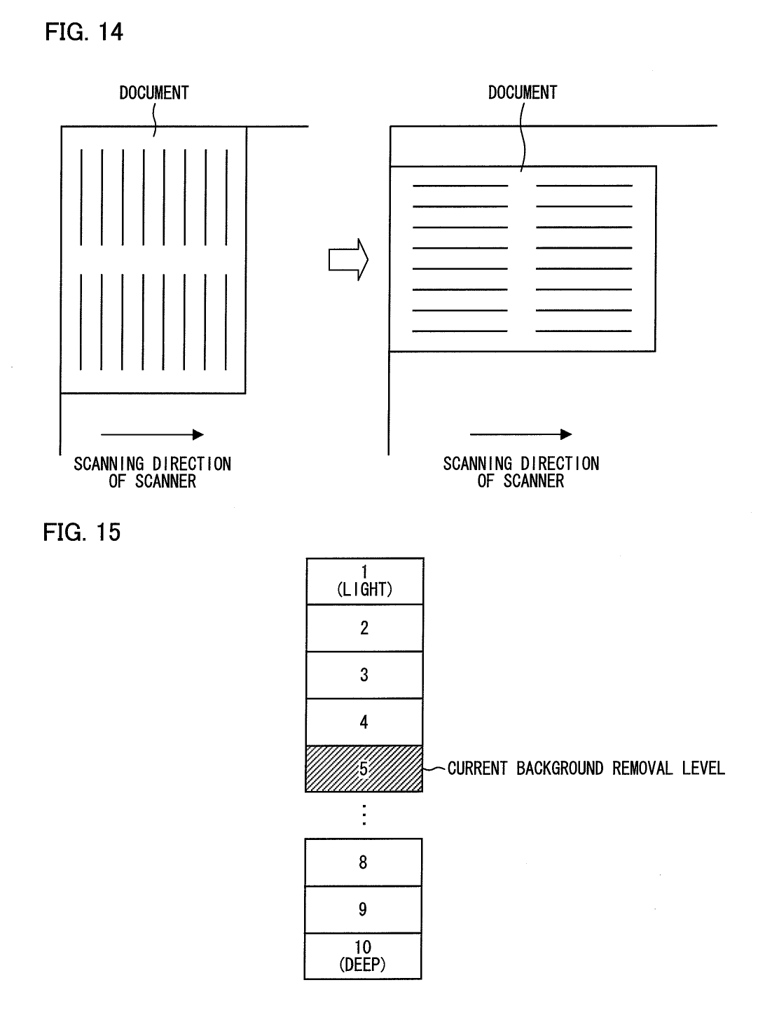

That is, in a case where, for example, a text direction of a document is not parallel with the sub-scanning direction, an orientation of the document is changed so that the text direction may be parallel with the sub-scanning direction while the document is re-read. Specifically, in a case where, for example, a 2-in-1 horizontally-written document has been vertically oriented while being read as is illustrated in FIG. 14, the document is horizontally oriented so as to be re-read.

It is also possible to change a resolution used at reading by the image input apparatus 2. Alternatively, it is also possible to change a resolution of a binarized image to be subjected to the character recognition process, i.e., a resolution converted by the resolution conversion section 33.

It is also possible to change a read density at which a document is read by the image input apparatus 2. (For example, it can be arranged such that a numeral or the like indicating a density level is displayed so that a user may select a new density level, and a light intensity of a light source and/or a gamma curve is changed in accordance with the selected new density level.

It is also possible to change a level at which the background removal is performed. For example, it can be arranged as below. A plurality of levels are set at which the background removal is performed. In addition, correction curves are prepared so as to correspond to the plurality of levels, respectively. As shown in FIG. 15, numerals or the like indicating the plurality of levels are displayed so that a user may select a desired level. Upon the selection of the desired level, the background removal is performed by using a correction curve corresponding to the selected level.

It can be arranged such that a user changes the setting above via a setting window of a computer system or the like which is connected with the operation panel 6 or the digital color multifunction printer 1 so that communication may be enabled therebetween.

In a case where the edit process section 54 corrects a character recognition result, the chromatic text generation section 52 generates color text data of the corrected character. Then, the image composition section 53 combines the document image data and the color text data corresponding to the corrected character. Then, the display control section 42 causes the display device 7 to display the combined image data.

In a case where a user instructs the edit process section 54 to end a process of correcting a character recognition result, the edit process section 54 outputs a fixed character recognition result to the draw command generation section 43.

(2-2-2) Image File Generation Process

Upon completion of the character recognition process, there is performed a process of generating an image file containing (i) image data obtained by subjecting image data read from a document to a predetermined process and (ii) text data generated in the character recognition process.

Specifically, the color correction section 16 converts, into R′G′B′ image data (e.g., sRGB data), the RGB image data inputted from the document correction section 15. The R′G′B′ image data conforms to the display characteristics of a commonly-used display device. Then, the color correction section 16 outputs the R′G′B′ image data to the black generation and under color removal section 17. In the regular transmission mode, the black generation and under color removal section 17 directly outputs (without subjecting the image data to any process), to the spatial filter process section 18, the image data inputted from the color correction section 16.

The spatial filter process section 18 performs, by use of a digital filter, a spatial filter process (edge enhancement process or smoothing process) on the R′G′B′ image data inputted from the black generation and under color removal section 17, in accordance with the segmentation class signal, and outputs the processed R′G′B′ image data to the output tone correction section 19.

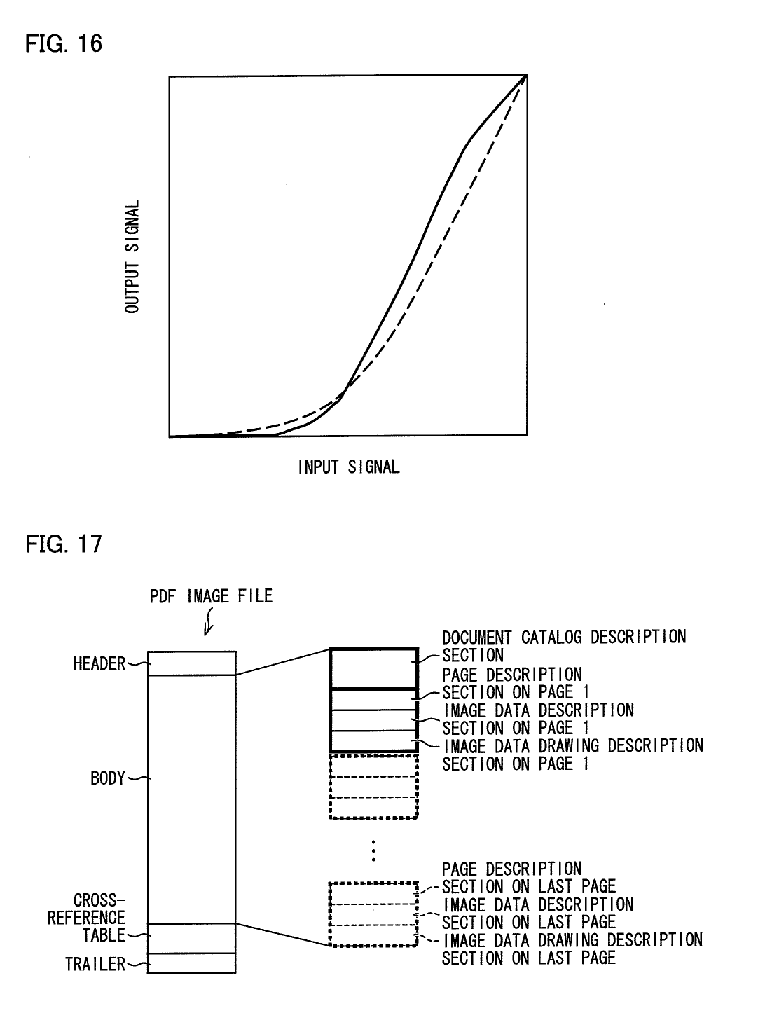

The output tone correction section 19 performs a predetermined process on the R′G′B′ image data inputted from the special filter process section 18, in accordance with the segmentation class signal, and outputs the R′G′B′ image data to the halftone generation section 20. For example, the output tone correction section 19 performs, on the text region, correction using a gamma curve shown by a solid line in FIG. 16, and performs, on a non-text region, correction using a gamma curve shown by a dotted line in FIG. 16. It is preferable that, for example, (i) set for non-text regions is a gamma curve corresponding to display characteristics of a display device provided to an external device of a destination; and (ii) set for the text region is a gamma curve for characters to be sharply displayed.

The halftone generation section 20 outputs, to the formatting process section 44 in the image file generation section 22, the R′G′B′ image data inputted from the output tone correction section 19 (without subjecting the processed R′G′B′ image data to any process).

The image file generation section 22 includes the character recognition section 41, the display control section 42, the draw command generation section 43, and the formatting process section 44.

The character recognition section 41 generates text data in accordance with a result of the character recognition process, and outputs the result to the draw command generation section 43. The text data contains respective character codes of characters and positions thereof.

The draw command generation section 43 generates a command for setting, in the image file, transparent text data in accordance with the character recognition result obtained by the character recognition section 41. The transparent text data is data for invisibly superimposing (or embedding), as text information, recognized characters and words on the image data. For example, in the case of a PDF file, an image file is commonly used in which such transparent text data is added to image data.

The formatting process section 44 generates an image file of a predetermined format, by embedding, into the image data inputted from the halftone generation section 20, the transparent text data in accordance with the command inputted from the draw command generation section 43. Then, the formatting process section 44 outputs the generated image file to the communication device 5. In the present embodiment, the formatting process section 44 generates a PDF image file. Note that a format of the image file is not limited to PDF but can be any format, provided that the transparent text data can be embedded in the image data, or the image data and the text data are correlated with each other.

FIG. 17 is an explanatory diagram showing an arrangement of a PDF image file generated by the formatting process section 44. As shown in FIG. 17, the PDF image file is made up of a header section, a body section, a cross-reference table, and a trailer section.

The header section contains a version number and a text string indicating that the file is a PDF file. The body section contains information to be displayed and page information. The cross-reference table describes address information for accessing contents of the body section. The trailer section describes, for example, information indicating where to start reading.

The body section is made up of a document catalog description section, a page description section, an image data description section, and an image drawing description section. The document catalog description section describes cross-reference information indicating an object constituted by each page. The page description section describes information such as on a display area for each page. The image data description section describes image data. The image drawing description section describes a condition to be applied at the time when a corresponding page is drawn. The page description section, the image data description section, and the image drawing description section are provided for each page.

The communication device 5 transmits, to an external device which is connected with the communication device 5 via a network so that communication therebetween may be enabled, the image file inputted from the formatting process section 44. For example, the communication device 5 causes a mail process section (job device; not illustrated) to attach the image file to an e-mail and transmit the e-mail to the external device.

(2-3) Overview of Processes in Image Processing Apparatus 3

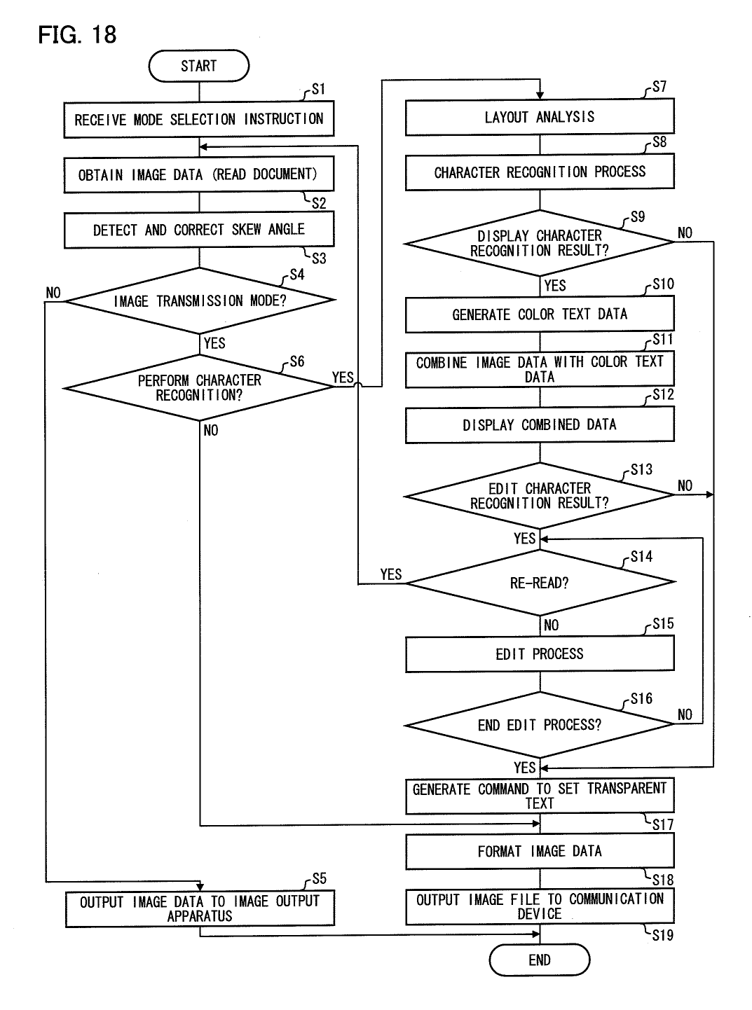

FIG. 18 is a flowchart schematically showing a process flow of the image processing apparatus 3. As shown in FIG. 18, first, the control section 24 receives an instruction to select a process mode from a user via the operation panel 6 (S1). Then, the control section 24 obtains, from the image input apparatus 2, image data obtained by reading a document (S2).

Then, the control section 24 causes the document detection section 14 to perform a skew angle detection process, and then, causes the document correction section 15 to perform a skew correction process in accordance with the detection result of the skew angle detection process (S3).

Then, the control section 24 determines whether or not the process mode selected in S1 is the image transmission mode (S5). If the control section 24 determines that the selected mode is not the image transmission mode, the control section 24 causes relevant sections of the image processing apparatus 3 to perform predetermined processes on the image data subjected to the skew correction process. Then, the control section 24 causes the image data to be outputted to the image output apparatus 4 (S5), and ends the processing.

If the control section 24 determines that the image transmission mode has been selected in S4, the control section 24 determines whether to perform the character recognition process (S6). This determination is made in accordance with, e.g., a user's selection instruction.

If the control section 24 determines not to perform the character recognition process, the control section 24 causes relevant sections of the image processing apparatus 3 to perform predetermined processes on the image data subjected to the skew correction process, and causes the formatting process section 44 to generate (to format) an image file having a predetermined format (S18). Then, the control section 24 causes the formatting process section 44 to output the generated image file to the communication device 5 (S19), and ends the processing.

If the control section 24 determines to perform the character recognition process, the control section 24 causes the layout analysis section 35 in the document detection section 14 to perform layout analysis (a process of determining whether a direction of text in a document image is the vertical direction or the horizontal direction) (S7). Then, the control section 24 causes the recognition process section 51 in the character recognition section 41 to perform the character recognition process in accordance with a text direction indicated by an analysis result obtained by the layout analysis section 35 (S8).

Then, the control section 24 determines whether to display the character recognition result (S9). This determination is made in accordance with a user's selection instruction.

If the control section 24 determines to display the character recognition result, the control section 24 causes the chromatic text generation section 52 to generate color text data on the basis of the character recognition result (S10). Then the control section 24 causes the image composition section 53 to combine image data read from a document and the color text data (S11). Then, by controlling the display control section 42, the control section 24 causes the display device 7 to display the combined image data (S12).

Then, the control section 24 determines whether to edit the character recognition result (S13). This determination is made in accordance with, e.g., a user's selection instruction.

If the control section 24 determines to edit the character recognition result, the control section 24 determines whether to obtain image data again (whether to re-read the document) (S14). If the control section 24 determines to obtain the image data again, S2 is performed again so that the image data is obtained again. In this case, as needed, a read condition can be changed under which the image input apparatus 2 reads the image data.

If the control section 24 determines not to obtain the image data again, the control section 24 edits (performs correction, deletion, and/or the like) the character recognition result in accordance with a user's instruction input (S15). Then, the control section 24 determines whether to end the editing process (S16). If the control section 24 determines not to end the editing process, S14 is carried out again.

If the control section 24 (i) determines, in S9, not to display the character recognition result, (ii) determines, in S13, not to edit the character recognition result, or (iii) determines, in S16, to end the editing process, the control section 24 causes the draw command generation section 43 to generate a command to set, in the image file, transparent text data generated in accordance with the character recognition result (S17).

Then, the control section 24 controls the formatting process section 44 so as to cause the formatting process section 44 to generate an image file having a predetermined format (S18). Specifically, the formatting process section 44 generates the image file by embedding, in the image data subjected to predetermined processes such as the skew correction process, the transparent text data generated in accordance with the command from the draw command generation section 43. Then, the control section 24 causes the communication device 5 to output the generated image file (S19). Then, the control section 24 ends the processing.

As described above, the digital color multifunction printer 1 of the present embodiment includes: the recognition process section 51 for performing, on the basis of image data of a document, the character recognition process on a character contained in the document; the chromatic text generation section 52 for generating color text data (character image data) indicative of character images in which characters with different attributes are displayed with different colors; image composition section 53 for generating composite image data, the composite image data generated by combining the image data of the document and the color text data so that each of the character images indicated by the color text data is partially superimposed on an image of a corresponding character in the document; and the display control section 42 for causing the display device to display an image indicated by the composite image data.

According to the arrangement, the character images indicated by the color text data and images of corresponding characters in the document are displayed so that each of the character images indicated by the color text data is partially superimposed on an image of a corresponding character in the document. This allows a user to compare more easily the characters in the document with the character recognition results. In addition, the character images based on the character recognition results are displayed in such a manner that characters with different attributes are displayed with different colors. This allows a user to easily discriminate individual character recognition results. As a result, the user can easily determine whether or not the character recognition results are correct, and edit the character recognition results as needed.

The image composition section 53 can be arranged to combine color text data with binarized image data obtained by binarizing document image data (for example, combine with that image data binarized by the document detection section 14 which has the first or second resolution). In this case, an image of the document is displayed in monochrome, and character recognition results are displayed in color. As a result, a user can compare the document image with the character recognition results more easily.

In the present embodiment, the document detection section 14 outputs, to the image file generation section 22, binarized image data having a reduced resolution. However, the present embodiment is not limited to this. For example, it can be arranged as below. The document correction section 15 outputs, to the image file generation section 22, the image data obtained by subjecting the binarized image having the reduced resolution to the skew correction process, and then, the character recognition section 41 in the image file generation section 22 performs the character recognition process by use of the image data subjected to the skew correction. This makes it possible to improve accuracy of the character recognition process, as compared to the character recognition process performed on the image data which is not subjected to the skew correction.

Further, in the present embodiment, the character recognition process is performed on the image data (i) which has been converted by the document detection section 14 to black-and-white binary values (luminance signal) and (ii) whose resolution is converted by the document detection section 14 to a low resolution (e.g., 300 dpi). This makes it possible to appropriately perform the character recognition process even if a character size is relatively large. Note that the resolution of the image to be used in the character recognition process is not limited to the example above.

Further, the present embodiment describes an example in which the formatting process section 44 generates a PDF image file. However, a format of the image file is not limited to this, but can be any format, provided that the image data and the text data are correlated with each other. For example, it can be also arranged such that the formatting process section 44 generates an image file in which text data is invisible and only image data is visible. Such an image file is generated as below. First, the text data is set in a format of presentation software or the like. Then, the image data is superimposed on the text data.

The present embodiment describes a case where the image data in which the transparent text data is embedded is transmitted to the external device via the communication device 5. However, the present embodiment is not limited to this. For example, it can be arranged such that the image data in which the transparent text data is embedded is stored (filed) in a storage section provided in the digital color multifunction printer 1 or in a storage section detachably provided to the digital color multifunction printer 1.

The present embodiment describes a case where the present invention is applied to a digital color multifunction printer. However, the present embodiment is not limited to this. For example, the present invention can be applied to a monochrome multifunction printer. Further, the present invention can be applied not only to a multifunction printer but also to, e.g., an image reading apparatus which has only an image reading function.

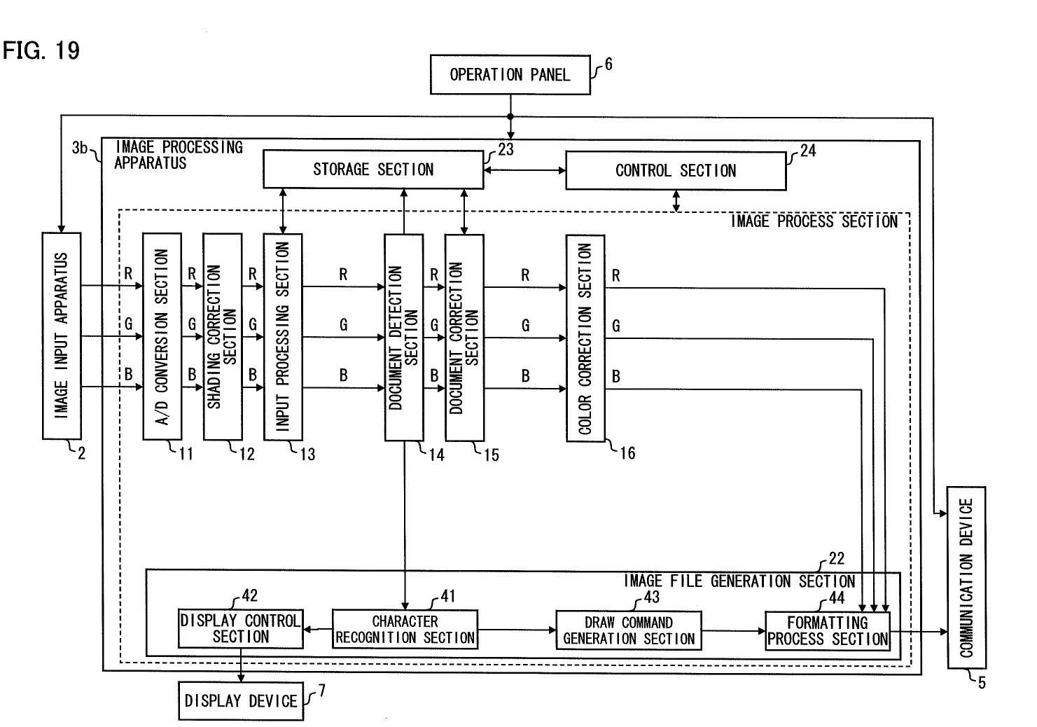

FIG. 19 is a block diagram showing an example of an arrangement in which the present invention is applied to an image reading apparatus. An image reading apparatus 100 shown in FIG. 19 includes an image input apparatus 2, an image processing apparatus 3b, a communication device 5, an operation panel 6, and a display device 7. Respective functions and arrangements of the image input apparatus 2, the communication device 5, and the operation panel 6 are substantially the same as those of the digital color multifunction printer 1 described above, and explanations thereof are omitted here.

The image processing apparatus 3b includes an A/D conversion section 11, a shading correction section 12, an input processing section 13, a document detection section 14, a document correction section 15, a color correction section 16, an image file generation section 22, a storage section 23, and a control section 24. Further, the image file generation section 22 includes a character recognition section 41, a draw command generation section 42, and a formatting process section 43.

The members above provided in the image processing apparatus 3b has functions substantially the same as those in the digital color multifunction printer 1 described above, except that: the image forming mode is not included; and the image data having been subjected to the color correction process by the color correction section 16 is outputted to the formatting process section 44 and the formatting process section 44 generates, in accordance with the image data inputted from the color correction section 16, an image file to be transmitted to the external device. The image file generated through the processes described above in the image processing apparatus 3b is transmitted, by the communication device 5, to, for example, a computer or a server communicably connected via a network.

In the present embodiment, each block in the digital color multifunction printer 1 or the image reading apparatus 100 may be realized by software by using a processor such as a CPU. In such a case, the digital color multifunction printer 1 or the image reading apparatus 100 includes a CPU (central processing unit) that executes the order of a control program for realizing the aforesaid functions, a ROM (read only memory) that stores the control program, a RAM (random access memory) that develops the control program in an executable form, and a storage device (storage medium), such as a memory, that stores the control program and various types of data therein. With this arrangement, the object of the present invention is realized by a predetermined storage medium. The storage medium stores, in a computer-readable manner, program codes (executable code program, intermediate code program, and source program) of the control program of the digital color multifunction printer 1 or the image reading apparatus 100 of the present invention, each of which is software for realizing the aforesaid functions. The storage medium is provided to the digital color multifunction printer 1 or the image reading apparatus 100. With this arrangement, the digital color multifunction printer 1 or the image reading apparatus 100 (alternatively, CPU or MPU) as a computer reads out and executes the program code stored in the storage medium provided.

The storage medium may be a tape such as a magnetic tape or a cassette tape; a disc such as a magnetic disk including a Floppy® disc and a hard disk, and an optical disk including a CD-ROM, an MO, an MD, a DVD, and a CD-R; a card such as an IC card (including a memory card) and an optical card; or a semiconductor memory, such as a mask ROM, an EPROM, an EEPROM, and a flash ROM.

Further, the digital color multifunction printer 1 or the image reading apparatus 100 of the present invention can be arranged so as to be connectable to a communications network so that the program code is supplied to the digital color multifunction printer 1 or the image reading apparatus 100 through the communications network. The communications network is not to be particularly limited. Examples of the communications network include the Internet, an intranet, an extranet, LAN, ISDN, VAN, a CATV communications network, a virtual private network, a telephone network, a mobile communications network, and a satellite communications network. Further, a transmission medium that constitutes the communications network is not particularly limited. Examples of the transmission medium include (i) wired lines such as IEEE 1394, USB, power-line carrier, cable TV lines, telephone lines, and ADSL lines and (ii) wireless connections such as IrDA and infrared ray used in remote control, Bluetooth®, 802.11, HDR, a mobile phone network, satellite connections, and a terrestrial digital network. Note that the present invention can be also realized by the program codes in the form of a computer data signal embedded in a carrier wave which is embodied by electronic transmission.

Each block of the digital color multifunction printer 1 or the image reading apparatus 100 is not limited to the block realized by software, but may be constituted by hardware logic or a combination of (i) hardware performing a part of the processes and (ii) operation means executing software performing control of the hardware and the rest of the processes.

As described above, an image processing apparatus of the present invention is an image processing apparatus for performing, on the basis of image data of a document, a character recognition process of recognizing a character contained in the document, the image processing apparatus including: a character image data generation section for generating character image data indicative of respective character images of characters recognized in the character recognition process; an image composition section for generating composite image data, the composite image data generated in such a manner that the image data of the document is combined with the character image data so that each of the character images indicated by the character image data is partially superimposed on a corresponding image of a character in the document; and a display control section for causing a display device to display an image in accordance with the composite image data, the character image data generation section determining a color of each of the character images in such a manner that character images with different attributes are displayed with different colors.

An image processing method of the present invention is an image processing method for performing, on the basis of image data of a document, a character recognition process of recognizing a character contained in the document, the image processing method including the steps of: (a) generating character image data indicative of respective character images of characters recognized in the character recognition process; (b) generating composite image data, the composite image data generated in such a manner that the image data of the document is combined with the character image data so that each of the character images indicated by the character image data is partially superimposed on a corresponding image of a character in the document; and (c) causing a display device to display an image in accordance with the composite image data, in the step of (a), a color of each of the character images being determined in such a manner that character images with different attributes are displayed with different colors.

According to the image processing apparatus and the image processing method, character image data is generated which indicates respective character images of characters recognized in the character recognition process; composite image data is generated by combining the image data of the document and the character image data so that each of the character images indicated by the character image data is partially superimposed on an image of a corresponding character in the document; and an image indicated by the composite image data is displayed by the display device. In addition, a color of each of the character images is determined in such a manner that character images with different attributes are displayed with different colors.

Accordingly, the character images indicated by the character image data and images of corresponding characters in the document are displayed so that each of the character images indicated by the character image data is partially superimposed on an image of a corresponding character in the document. This allows a user to compare more easily the characters in the document with the character recognition results. In addition, the character images based on the character recognition results are each displayed in a color which is changed according to a attribute of a character indicated by each of the character images. This allows a user to easily discriminate individual character recognition results. As a result, the user can easily determine whether or not the character recognition results are correct, and edit the character recognition results as needed. The attribute encompasses, e.g., a feature (e.g., fonts, character types (Chinese characters, hiraganas (Japanese cursive syllabary), katakanas (Square Japanese syllabary), alphanumeric characters, etc.), character size (point), etc.) of a character, a type of a region (e.g., text region and photograph region) in an image, and a page type (e.g., an odd page or an even page) in a document image.

Further, it can be arranged such that the image processing apparatus further includes an operation input section for receiving a user's instruction input, and the character image data generation section determines, in accordance with the user's instruction input, the color of each of the character images.

According to the arrangement, a user can set a color of each attribute of character images based on character recognition results, so that the color changes according to a attribute of a character indicated by each attribute of the character images. This allows the user to check the character recognition results more easily.

Further, it can be arranged such that the image processing apparatus further includes a segmentation process section for separating, on the basis of the image data of the document, a region on the document into at least a text region and another region, and the character image data generation section determines the color of each of the character images in such a manner that character images in different types of regions are displayed with different colors.

According to the arrangement, a color of each of the character images based on the character recognition results is changed according to a type of a region. This allows a user to easily discriminate a character recognition result obtained from a text region from a character recognition result obtained from other regions.

Further, it can be arranged such that the image processing apparatus further includes an operation input section for receiving a user's instruction input, and when combining the image data of the document with the character image data, the image composition section changes, in accordance with the user's instruction input, relative positions of the character images indicated by the character image data with respect to corresponding images of characters on the document.

According to the arrangement, a user can adjust positions where character images of characters recognized in the character recognition process are displayed. This allows the user to compare more easily the characters in the document with the character recognition results of the characters.

Further, the image processing apparatus can further include: an operation input section for receiving a user's instruction input; and an edit process section for editing a result of the character recognition process in accordance with the user's instruction input.

According to the arrangement, on the basis of a check result of whether or not the character recognition results are correct, a user can correct a result of the character recognition process, and/or partly delete the character recognition results.

Further, it can be arranged such that the image processing apparatus further includes a segmentation process section for separating, on the basis of the image data of the document, a region on the document into at least a text region and another region; the display control section displays the text region and another region in a distinguishable manner; and the edit process section deletes, at a time, a result of the character recognition process, when the result is obtained from a region specified by the user.

According to the arrangement, by specifying a region which does not require the character recognition result, a user can delete, at a time, the character recognition results obtained from the region. This makes it possible to reduce time for editing character recognition results.

Further, the image processing apparatus can further include an image file generation section for generating an image file in which text data based on a result of the character recognition process is correlated with the image data of the document.

According to the arrangement, a user can perform a keyword search on the generated image file.

Further, the image file generation section can be arranged to superimpose, as transparent text, character images indicated by the text data on corresponding images of characters on the document.

According to the arrangement, a user can easily specify that character in the document which corresponds to a character found in the keyword search.

An image forming apparatus of the present invention includes: an image input apparatus for obtaining image data of a document by reading the document; any one of the image processing apparatuses; and an image forming section for forming an image on a recording material in accordance with the image data of the document.

According to the arrangement, it is possible to (i) perform the character recognition process on the document on the basis of the document image data read by the image input apparatus, and (ii) easily check whether or not the character recognition results are correct.

Note that the image processing apparatus may be realized by a computer. In such a case, the scope of the present invention encompasses an image processing program and a computer-readable storage medium storing the image processing program for realizing the image processing apparatus by use of the computer by causing the computer to operate as the sections described above.

The present invention is not limited to the embodiments described above, and may be modified within the scope of the claims. An embodiment based on a proper combination of technical means disclosed in different embodiments is also encompassed in the technical scope of the present invention.

### INDUSTRIAL APPLICABILITY

The present invention is applicable to an image processing apparatus which performs a character recognition process on image data read from a document, an image reading apparatus, and an image transmitting device.

### REFERENCE SIGNS LIST

1 Digital Color Multifunction Printer (Image Reading Apparatus, Image Transmitting Device, and image forming apparatus)
2 Image Input Apparatus
3, 3b Image Processing Apparatus
5 Communication Device
6 Operation Panel
7 Display device
14 Document Detection Section
21 Segmentation Process Section
22 Image File Generation Section
23 Storage Section
24 Control Section
25 Automatic document type discrimination section
31 Signal Conversion Section
32 Binarization Process Section
33 Resolution Conversion Section
34 Document Skew Detection Section
35 Layout Analysis Section
41 Character Recognition Section
42 Display control section
43 Draw Command Generation Section
44 Formatting Process Section
51 Recognition process section
52 Chromatic text generation section (character image data generation section)
53 Image composition section
54 Edit process section
100 Image Reading Apparatus

1. An image processing apparatus for performing, on the basis of image data of a document, a character recognition process of recognizing a character contained in the document, the image processing apparatus comprising:
a character image data generation section for generating character image data indicative of respective character images of characters recognized in the character recognition process;
an image composition section for generating composite image data, the composite image data generated in such a manner that the image data of the document is combined with the character image data so that each of the character images indicated by the character image data is partially superimposed on a corresponding image of a character in the document; and
a display control section for causing a display device to display an image in accordance with the composite image data,
the character image data generation section determining a color of each of the character images in such a manner that character images with different attributes are displayed with different colors.

2. The image processing apparatus as set forth in claim 1, further comprising an operation input section for receiving a user's instruction input,
the character image data generation section determining, in accordance with the user's instruction input, the color of each of the character images.

3. The image processing apparatus as set forth in claim 1, further comprising a segmentation process section for separating, on the basis of the image data of the document, a region on the document into at least a text region and another region,
the character image data generation section determining the color of each of the character images in such a manner that character images in different types of regions are displayed with different colors.

4. The image processing apparatus as set forth in claim 1, further comprising an operation input section for receiving a user's instruction input,
when combining the image data of the document with the character image data, the image composition section changing, in accordance with the user's instruction input, relative positions of the character images indicated by the character image data with respect to corresponding images of characters on the document.

5. The image processing apparatus as set forth in claim 1, further comprising:
an operation input section for receiving a user's instruction input; and
an edit process section for editing a result of the character recognition process in accordance with the user's instruction input.

6. The image processing apparatus as set forth in claim 5, further comprising a segmentation process section for separating, on the basis of the image data of the document, a region on the document into at least a text region and another region,
the display control section displaying the text region and another region in a distinguishable manner, and
the edit process section deleting, at a time, a result of the character recognition process, the result obtained from a region specified by the user.

7. The image processing apparatus as set forth in claim 1, further comprising an image file generation section for generating an image file in which text data based on a result of the character recognition process is correlated with the image data of the document.

8. The image processing apparatus as set forth in claim 7, wherein the image file generation section superimposes, as transparent text, character images indicated by the text data on corresponding images of characters on the document.

9. An image forming apparatus comprising:
an image input apparatus for obtaining image data of a document by reading the document;
an image processing apparatus for performing, on the basis of the image data of the document, a character recognition process of recognizing a character contained in the document; and
an image forming section for forming an image on a recording material in accordance with the image data of the document,
the image processing apparatus including:
a character image data generation section for generating character image data indicative of respective character images of characters recognized in the character recognition process;
an image composition section for generating composite image data, the composite image data generated in such a manner that the image data of the document is combined with the character image data so that each of the character images indicated by the character image data is partially superimposed on a corresponding image of a character in the document; and
a display control section for causing a display device to display an image in accordance with the composite image data,
the character image data generation section determining a color of each of the character images in such a manner that character images with different attributes are displayed with different colors.

10. An image processing method for performing, on the basis of image data of a document, a character recognition process of recognizing a character contained in the document, the image processing method comprising the steps of:
(a) generating character image data indicative of respective character images of characters recognized in the character recognition process;
(b) generating composite image data, the composite image data generated in such a manner that the image data of the document is combined with the character image data so that each of the character images indicated by the character image data is partially superimposed on a corresponding image of a character in the document; and
(c) causing a display device to display an image in accordance with the composite image data,
in the step of (a), a color of each of the character images being determined in such a manner that character images with different attributes are displayed with different colors.

11. A computer-readable recording medium storing a program for causing an image processing apparatus to operate, the image processing apparatus being for performing, on the basis of image data of a document, a character recognition process of recognizing a character contained in the document,
the program being for causing a computer to function as:
a character image data generation section for generating character image data indicative of respective character images of characters recognized in the character recognition process, the character image data generation section determining a color of each of the character images in such a manner that character images with different attributes are displayed with different colors;
an image composition section for generating composite image data, the composite image data generated in such a manner that the image data of the document is combined with the character image data so that each of the character images indicated by the character image data is partially superimposed on a corresponding image of a character in the document; and
a display control section for causing a display device to display an image in accordance with the composite image data.
